(19) United States
(12) Patent Application Publication
(10) Pub. No.: US 2009/0130498 A1
(43) Pub. Date: May 21, 2009

(54) METHOD FOR THE IMPROVEMENT OF THE CATALYTIC AND PHOTOCATALYTIC PROCESSES BY MEAN OF LASER IRRADIATION

(76) Inventor: Victor Chepettchouk, Richmond Hill (CA)

Correspondence Address: VICTOR CHEPETTCHOUK, 46 GRAND OAK DRIVE, RICHMND HILL, ON, L4E-3Z9, CA

(21) Appl. No.: 11/941,952

(22) Filed: Nov. 18, 2007

(51) Int. Cl. H01M 8/04; G21K 5/00; H01S 3/00

(52) U.S. Cl. 429/13; 250/492.1

(57) ABSTRACT

Method for the improvement of the catalytic and photo-catalytic processes by mean of laser or multiple laser irradiations applying to chemical components, when molecules, atoms, and electrons transfer into excited state. This method could be used for improving fuel cells performance and in chemical reactors,

### FIELD OF INVENTION

The present invention relates to the method for improving catalytic and photo-catalytic processes by the means of resonance laser irradiation when molecules, atoms, and electrons transfer into their excited state.

Method could be used for chemical reactors and fuel cell performance improvement, when laser irradiation transfers fuel molecules into excited state, improving photocatalytic process.

Method could be used for improving chemical reactions where using of resonance laser irradiation or multiple laser irradiations with laser wavelengths selected in such way, that chemical components molecules, atoms and electrons will be transferred into excited state.

### BACKGROUND

Chemical reactors rather often require expensive catalysts and/or high operational temperature to support functionality.

Fuel cell technology is a classical example of using catalytic and photo-catalytic processes, so the method applicability will be justify using fuel cell technology.

Should be understand, that this methodology could be use in any type or chemical reactor, where using of laser irradiation is practical.

A fuel cell is an electrochemical device for generating electrical power.

There are different types of fuel cells.

Direct methanol fuel cell is described in U.S. patent application US200510181258A1 [0002, 0003, 0004]

Reformed types of fuel cells require high operational temperature and are described in U.S. Pat. Nos. 4,976,747 (sections 15, 45, 50, 60), 4,181,503 (sections 35, 45, 50, 55, 60).

The U.S. patent application US 2005/0226808A1 [0019; 0036; 0039; 0041] describes hydrogen gas production from organic fuel in presence of catalyst using laser irradiation.

Fuel cells and chemical reactors require the use of expensive catalytic elements to be used for the catalytic and/or photo-catalytic processes and/or use of high operational temperature, as in reformed types of fuel cell, case.

The purpose of this invention is to improve catalytic process, and use catalytic elements more efficient, and reduce operational temperature.

### BRIEF SUMMARY OF INVENTION

The present invention presents a method for chemical catalytic and photo-catalytic performance improvement.

The method includes the use of resonance laser irradiation. For fuel cell, in the case of hydrogen using as fuel, fuel laser irradiation will transfer hydrogen in excited state by mean of transfer electrons into higher orbits separation reaction with catalyst will result in:

H₂ (resonance laser irradiation+catalyst)→2H⁴+2^{e-} (1)

Resonance laser irradiation or multiple laser resonance irradiation could be used for different type of fuel when different wavelengths selected.

As for RMFC type of fuel cells chemical process

CH₃OH→2H₂+CO (2)

CO+H₂O→H₂+CO₂ (3)

requires high operational temperature in conventional fuel cell.

Different wavelengths laser resonance irradiation selected for fuel and water vapour will transfer fuel and water molecules in excited state as result reducing required operational temperature.

The invention features a single laser or multiple lasers with different wavelengths and optical device, allowing irradiates fuel cell separation area, or chemical reactor internal area.

Invention also includes an optically transparent window which allows transferring laser irradiation into fuel cell separation area or chemical reactor internal area, or lasers could be installed in chemical reactor or fuel cell housing.

### DETAILED DESCRIPTION OF INVENTION

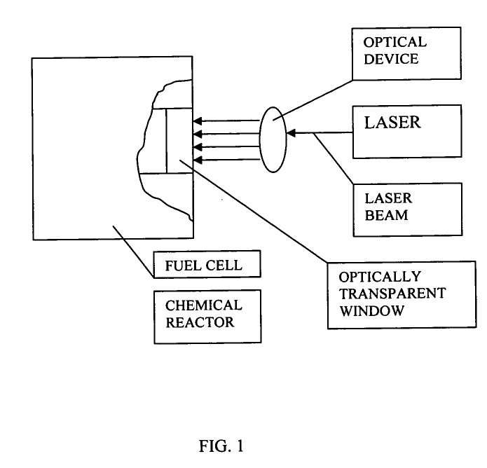

FIG. 1 is a drawing illustrating simplified chemical reactor with laser irradiation device.

The present invention presents methods of fuel cell or chemical reactors performance improvement.

The method includes use of laser or lasers to irradiate chemical reactors internal area, or fuel cell separation chamber, or reformed methanol chamber.

Resonance laser irradiation transfers molecules, atoms, electrons into excited state resulting in chemical and/or catalytic processes improvement.

Multiple lasers with different wavelengths could be used to irradiate different chemical reactants, such as different fuel cell types and water, required for certain fuel cell types.

The invention also includes optical device to split laser beam, or different wavelengths laser beams to irradiate chemical reactor internal area, or fuel cell separation chamber.

The invention includes optically transparent window installed in fuel cell housing allowing laser irradiation to penetrate inside fuel cell.

What is claimed is:

1. A method for fuel cell performance improvement when resonance laser irradiation transferring molecules, atoms, electrons into excited state result in chemical and/or catalytic process improvement.

2. A method for chemical reactors performance improvement when resonance laser irradiation transferring molecules, atoms, electrons into excited state result in chemical andior catalytic process improvement.

3. A method for fuel cell performance improvement, when laser or multiple lasers with different wavelengths are used to irradiate chemical reactor internal area, or fuel cell separation chamber, or reformed methanol chamber.

4. A method for fuel cell performance improvement, when laser or lasers with different wavelengths are used to irradiate water and organic fuel in fuel cell separation chamber.

5. A method for fuel cell performance improvement when resonance laser irradiation ionised water molecules, and laser irradiation ionized felt molecules.

6. A method for fuel cell performance improvement when laser irradiation transfers fuel molecules in excited state, resulting in catalytic process improvement and acceleration of chemical reactions.

7. A method for fuel cell performance improvement when laser irradiation transfers water molecules in excited state, resulting in catalytic process improvement and acceleration of chemical reactions.

8. An optical device transferring laser beam into ray covering fuel cell separation area.

9. An optically transparent window installed in fuel cell housing allowing laser or laser rays penetrate inside fuel cell.

10. Laser or lasers could be installed with optical devices as claimed in 8 and 9, or without optical devices directly in fuel cell housing.
